(19) United States
(12) Patent Application Publication
(10) Pub. No.: US 2011/0078166 A1
(43) Pub. Date: Mar. 31, 2011

(54) METHOD AND APPARATUS FOR CREATING AND UTILIZING INFORMATION REPRESENTATION OF QUERIES

(75) Inventors: Ian Justin Oliver, Soderkulla (FI); Jukka Honkola, Espoo (FI); Juha-Pekka Luoma, Espoo (FI)

(73) Assignee: Nokia Corporation, Espoo (FI)

(21) Appl. No.: 12/569,152

(22) Filed: Sep. 29, 2009

(51) Int. Cl. G06F 17/30

(52) U.S. Cl. 707/760; 707/E17.07; 707/759; 707/769

(57) ABSTRACT

An approach is provided for creating and utilizing information representation of queries. A query application receives a query. The query application expresses the query as a resource description framework graph. The query application causes at least in part storage of the query resource description framework graph.

### BACKGROUND

Service providers (e.g., wireless and cellular services) and device manufacturers are continually challenged to deliver value and convenience to consumers by, for example, providing compelling network services and advancing the underlying technologies. One area of interest has been in ways to increase response efficiency for user search queries, such as automatically updating a query thus updating results of the query without user involvement. However, existing query management in the semantic web is static. As a result, the user has to send out a new query even if there is only a minor change to the query.

### SOME EXAMPLE EMBODIMENTS

Therefore, there is a need for efficient query management in the semantic web by creating and utilizing an information representation of queries to automatically update a query and corresponding results without user involvement.

According to one embodiment, a method comprises receiving a query. The method also comprises expressing the query as a resource description framework (RDF) graph. The method further comprises causing at least in part storage of the query resource description framework graph.

According to another embodiment, an apparatus comprising at least one processor, and at least one memory including computer program code, the at least one memory and the computer program code configured to, with the at least one processor, cause the apparatus to receive a query. The apparatus is also caused to express the query as a resource description framework graph. The apparatus is further caused to cause at least in part storage of the query resource description framework graph.

According to another embodiment, a computer-readable storage medium carrying one or more sequences of one or more instructions which, when executed by one or more processors, cause an apparatus to receive a query. The apparatus is also caused to express the query as a resource description framework graph. The apparatus is further caused to cause at least in part storage of the query resource description framework graph.

According to another embodiment, an apparatus comprises means for receiving a query. The apparatus also comprises means for expressing the query as a resource description framework graph. The apparatus further comprises means for causing at least in part storage of the query resource description framework graph.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a conventional RDF graph, according to one embodiment;

FIGS. 2A-2B are diagrams of RDF graphs including representations of queries, according to various embodiments;

FIG. 3 is a diagram of a system capable of creating and utilizing information representation of queries, according to one embodiment;

FIG. 4 is a flowchart of a process for creating and utilizing information representation of queries, according to one embodiment;

FIG. 5 is a diagram of expanded RDF classes, according to one embodiment;

FIG. 6 is a diagram of the components of a query application, according to one embodiment;

FIGS. 7A-7C are diagrams of query RDF graph caching, according to various embodiments;

FIG. 8 is a diagram of a smart space logical architecture, according to one embodiment;

FIG. 9 is a flowchart of a process for query, insert, and subscribe operations, according to one embodiment;

FIG. 10 is a flowchart of a process for local and external subscription, according to one embodiment;

FIG. 11 is a flowchart of a process for delete and update operations, according to one embodiment;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal (e.g., a handset) that can be used to implement an embodiment of the invention.

### DESCRIPTION OF SOME EMBODIMENTS

A method and apparatus for efficiently creating and utilizing information representation of queries are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

The approach described herein is discussed with respect a “semantic web.” As used herein, the term “semantic web” refers to a universal medium for data, information, and knowledge exchange. This information exchange inserts documents with computer-comprehensible meaning (semantics) and makes them available on the semantic web. The semantic web is a “web of data” instead of the “web of documents.” Knowledge in the semantic web is structured and organized at a finer level of granularity than free-text document, and the vocabulary includes not only literal words but also universal identifiers.

Traditionally, query management in the semantic web has been based on sets of rules or policies which are predetermined by protocol or language developing committees. For instance, the Resource Description Framework (RDF) is a set of specifications developed by the World Wide Web Consortium (W3C) and used as a general method for conceptual description or modelling of information that is implemented in web resources. An RDF graph is a set of RDF triples. The term “triple” refers to a subject-predicate-object expression in RDF. A subject denotes the resource and is an RDF Uniform Resource Identifier (URI) reference or a blank node, a predicate is an RDF URI reference which denotes traits or aspects of the resource and expresses a relationship between the subject and the object, and an object is an RDF URI reference, a literal or a blank node. For example, one way to represent the notion “the manager went to Finland for a business negotiation” in RDF as the triple is: a subject denoting “the manager,” a predicate denoting “went to,” and an object denoting “Finland for a business negotiation.” RDF query languages, such as SPARQL Protocol and RDF Query Language (SPARQL), were set with a mechanism for locally defining subgraphs or scopes of an RDF graph. However, these subgraphs or scopes are embedded into the RDF query language and are defined explicitly in the form of RDF query language when the query is written. As dictated by the conventional protocol, once a query is written in the query language, it cannot be updated. As a result, the user needs to send out a new query every time the query is changed. For example, Alice queries the semantic web for all her friends' names. If Alice wants to change the query to be more specific to the names of her college friends, Alice has to send out or initiate a new query.

RDF databases, such as Redland, provide a more dynamic mechanism for a user and/or an administrator to explicitly define a scope of a RDF graph, but this RDF structure is defined when an RDF database is created. For example, the user and/or the administrator have the flexibility to introduce a RDF structure during run-time. However, by rule, this RDF structure is always placed “outside” of the RDF database structure. In addition, the user and/or the administrator have to know the existence of this RDF structure in order to use the RDF structure.

Conventional techniques for querying the semantic web can be used when queries are static, but cannot generate optimal results when applied to dynamically changing queries. To address this problem, the approach described herein introduces a new RDF parameter type and macros (i.e., sets of commands) to manage RDF graphs representing queries in order to dynamically change queries and update query results in the semantic web.

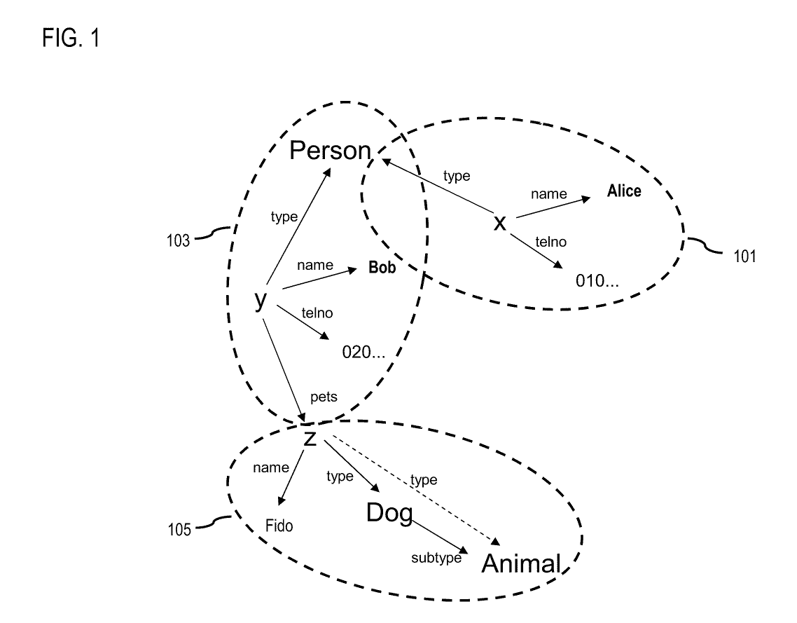

FIG. 1 is a diagram of a conventional RDF graph, according to one embodiment. This RDF graph contains three information subgraphs: One subgraph 101 of information regarding a person is represented by a uniform resource identifier (URI) “x,” and shown within an oval in a broken line on the top right of FIG. 1 The subgraph 101 contains “Person” as the type information, “Alice” as the name information, and “010 . . . ” as the telephone number information Another subgraph 103 of information regarding a person is represented by a URI “y,” and shown within an oval in a broken line on the left of FIG. 1. The subgraph 103 contains “Person” as the type information, “Bob” as the name information, and “020 . . . ” as the telephone number information. A third subgraph 105 of information regarding a pet is represented by a URI “z,” and shown within an oval in a broken line on the bottom of FIG. 1. The third subgraph 105 contains “Animal” or “Dog” as the type information, “Fido” as the name information, “Animal” as the subtype information, and “y” as the owner information. A scope is the context within which a statement is valid.

By way of example, a query can be executed on the RDF graph of FIG. 1 to retrieve information (e.g., to retrieve a person's name from the RDF graph). Properties associated with a query for retrieving a person's name may include, for instance, the scope (e.g., context), name, and query. In other embodiments, properties such as telno (i.e., telephone number), age, hairColour, socialSecurityNumber, etc. are also included in a scope. In one embodiment, a query command for a person's name and corresponding query results (e.g., Alice or Bob) are expressed in Windows Management Instrumentation Query Language (WQL) in Table 1. WQL queries usually return sets of URIs, literals, bags, or sequences. In this example, the query return set includes literals: Alice and Bob.

TABLE 1

Person | (:seq (:inv type) name)
returns: { Alice Bob }

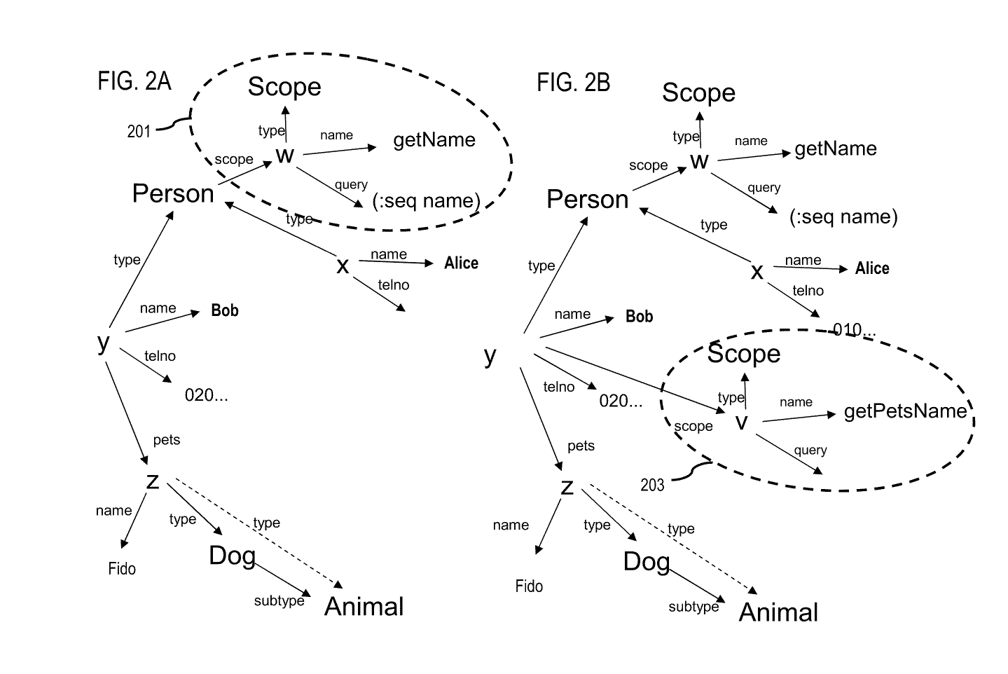

FIGS. 2A-2B are diagrams of RDF graphs including representations of queries, according to various embodiments. FIG. 2A is a diagram of a RDF graph according to one embodiment. In the approach described herein, a query is expressed as an RDF subgraph 201 and embedded into the conventional RDF graph of FIG. 1. By embedding the query as the RDF subgraph 201, the results of the query can be automatically updated with changes to the query. As previously discussed, under conventional RDF querying mechanisms, changes to the query typically would require retransmission of the query to obtain updated results. In this example, the query command for a person's name as described with respect to FIG. 1 is expressed as a “scope” (i.e., a query subgraph) using the same RDF information mechanism for the query in Table 2.

TABLE 2

getName(s:Person) −>
return s | (:seq name)

The RDF graph of the query for a person's name is shown as a subgraph 201 in FIG. 2A which is within an oval in a broken line on the top of FIG. 2A. The subgraph 201 of information regarding the query is represented by an URI “w.” As shown, the subgraph 201 contains “Scope” as the type information, “getName” as the query information, and “(:seq name)” as the name information. It is contemplated that the approach for expressing a query as a RDF graph is applicable for single value parameters as well as for multiple value parameters.

In this example, the scope is attached to the type: Person in FIG. 2A so as to make the query upon the RDF graph of FIG. 1. Although various embodiments are described here with respect to WQL, it is contemplated that the embodiments described in this application may be used with other RDF query languages such as SPARQL, DQL, N3QL, R-DEVICE, RDFQ, RDQ, RDQL, RQL/RVL, SeRQL, Versa, XUL, Adenine, etc.

In addition, the query scope is augmented with a macro construction: “:call.” The macro “:call” takes a scope name as a parameter, and then checks whether a scope of the given name exists on the type of the given frame (e.g., x). In this way, “:call” performs the type-checking function of the where-clause for RDF queries, thus making the current where-clause redundant. The where-clause is usually the largest and most detailed clause of the select command which specifies the variables to solve for and their order in the result. The where-clause specifies the constraints (i.e., RDF triples) that are satisfied by the variable values in each solution. As used herein, a constraint is a sequence of subject, predicate and object that represents an RDF statement. Each of the three positions (e.g., subject, predicate, or object) is either a constant value (a resource or a literal) or a variable.

For a query for a person's name in the subgraph 101, a scope is defined as URI/frame x. By way of example, the macro “:call” ensures that the object of the :call “getName” satisfies the following pre-condition: x.type.scope.name=“getName.” The query expression associated with the query scope is injected into the WQL query giving: x|(:seq name) in Table 3, and the query is processed as conventional queries in WQL.

TABLE 3

x | (:call getName)
returns {Alice}

Furthermore, a variation of “call:” named “:call_i” can be augmented to a query scope, which checks that the scope exists on the current instance (which usually involves specific information such as a pet's name) according to one embodiment of the invention. On the other hand, “call:” is applied to a type which usually involves frequently circulated information such as personal details. For example, the macro “:call_i” is used to find a pet's name in the subgraph 103, e.g., URI/frame y. The query for a pet's name against the subgraph 103 and the corresponding query result are conventionally expressed in WQL in Table 4.

TABLE 4

y | (:seq pets name)
returns: {Fido}

In this example, a special query scope for a pet's name is augmented to the RDF graph of FIG. 2A as shown in the RDF graph of FIG. 2B. The WQL expression of the pet's name query is shown as a subgraph 203 on the right side of FIG. 2B within an oval in a broken line. The subgraph 203 of information regarding the pet's name query is represented by a URI “v.” For example, the subgraph 203 contains “Scope” as the type information, “getPetsName” as the query information, and “(:seq pets name)” as the name information. The command of “:call_i getPetsName” retrieves pets' names in the RDF graph of FIG. 2B. This command ensures that for the scope of this query, the object of the :call_i “getPetsName” satisfies the following pre-condition: y.scope.name=“getPetsName”. The query expression associated with the special query scope is injected into the WQL query giving: y|(:seq pets name) in Table 5, and then the query is processed as conventional queries in WQL.

TABLE 5

y | (:call_i getPetsName)
returns {Fido}

In one embodiment, the difference between :call and :call_i is in the defined scope for each macro. The macro :call is generally used where the scope is defined on the types of the context URI of interest, while the macro :call_i is generally used where the scope is defined on specific instances of information. More specifically, the macro :call_i enables specific queries to be associated with specific information. It is noted that the macro :call_i typically is used less frequently than the macro :call.

A query can be defined with respect to a scope and expressed as a standardized RDF graph structure that is extensible, according to the described embodiments. A query RDF graph embedded into an existing RDF graph as shown in FIGS. 2A-2B is self-referential and can be updated at run time without user involvement. Query results can be obtained with macros (e.g., :call and :call_i) addressed to an RDF graph embedded with a query subgraph (e.g., the RDF graphs of FIGS. 2A and 2B). The described embodiments produce a mnemonic query organizational structure and significantly increased query management efficiency.

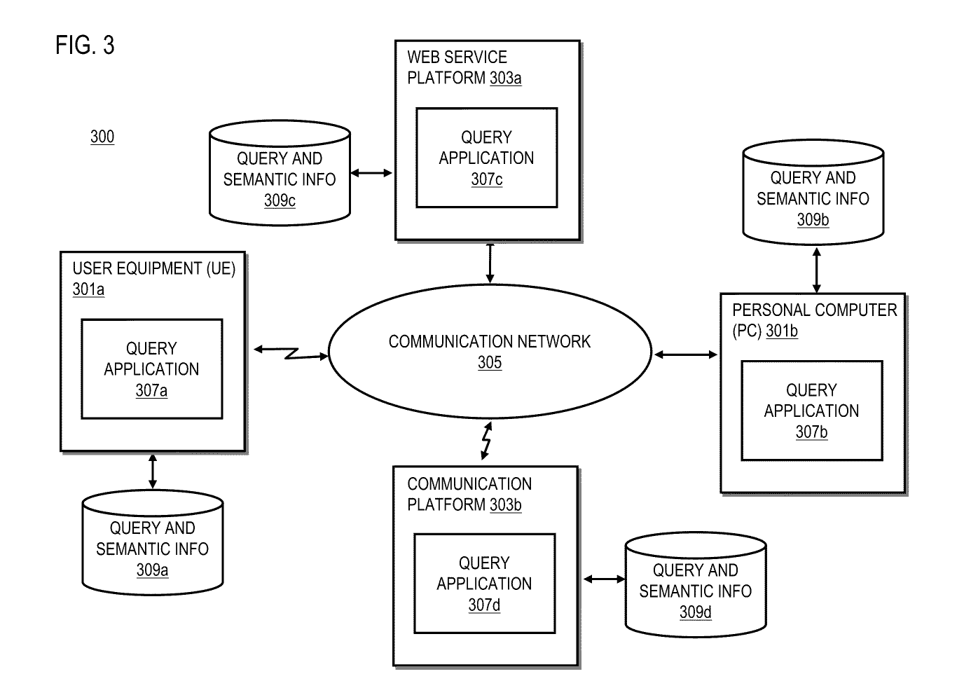

FIG. 3 is a diagram of a system 300 capable of creating and utilizing information representation of queries, according to one embodiment. As shown in FIG. 3, the system 300 comprises a user equipment (UE) 301a having connectivity to a personal computer 301b, a web service platform 303a, and a communication platform 303b via a communication network 305. Each of the UE 301a, the personal computer 301b, the web service platform 303a and the communication platform 303b has a query application 307 and a database 309 for storing query and semantic information.

By way of example, the communication network 305 of system 300 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 301a is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 301a can support any type of interface to the user (such as “wearable” circuitry, etc.).

By way of example, the UE 301a, the personal computer 301b, the web service platform 303a and the communication platform 303b communicate with each other and other components of the communication network 305 using well known, new or still developing protocols. In this context, a protocol includes a set of rules defining how the network nodes within the communication network 305 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

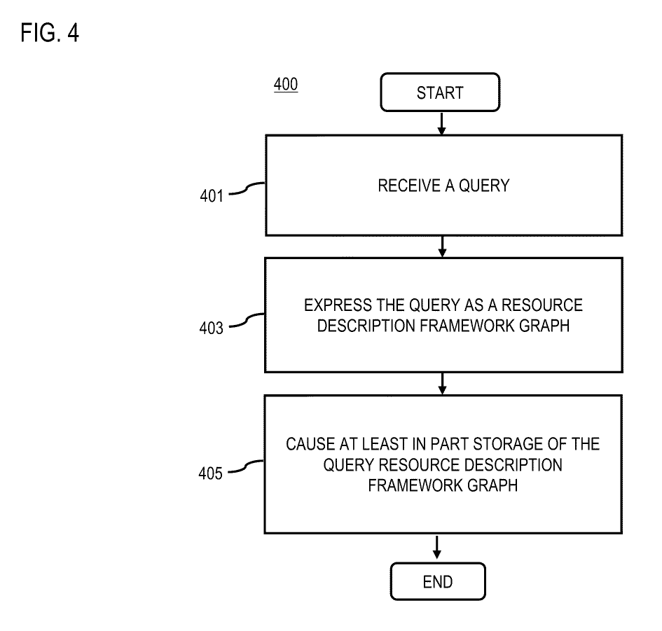

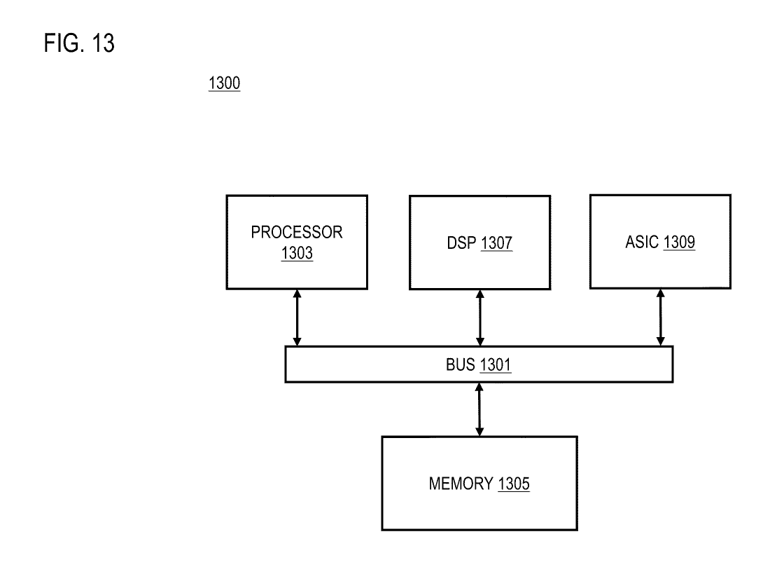

FIG. 4 is a flowchart of a process 400 for creating and utilizing information representation of queries, according to one embodiment. In one embodiment, the query application 307 performs the process 400 and is implemented in, for instance, a chip set including a processor and a memory as shown FIG. 13. In step 401, the query application 307 receives a query, for example, for personal details (e.g., a name, an age, hair color, and a telephone number) addressed to a URI x. In this embodiment, the query application 307 expresses the query as a RDF graph by defining a scope as discussed previously, and in WQL (Step 403) in Table 6.

TABLE 6

| scope PersonDetails(x) | |
|---|---|
| where x.rdf_type in u_Person | |
| then ( union | ( x \| name ) |

( x | age )
( x | hairColour )
( x | telephoneNumber )

)

else fail.

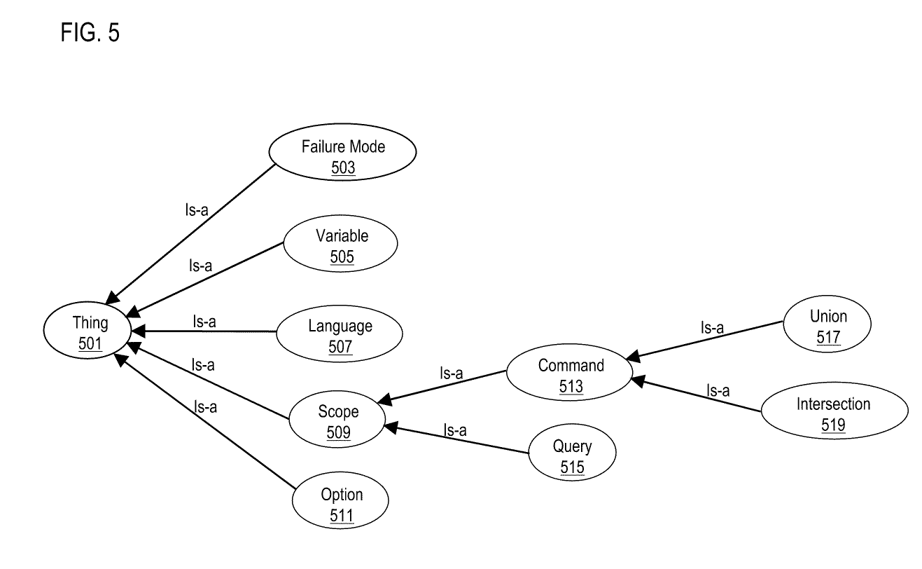

This scope statement indicates that given a URI/frame “x” (x is variable) where x is in the type u_Person, returns the set of results which is the union of the four sub-queries: x.name, x.age, x.hairColour, x.socialSecurityNumber, otherwise returns fail (i.e., x is not in the type u_Person). The operators used in this case are “union” and “intersection” which take two or more operands respectively as discussed later with respect to FIG. 5. Other manipulation operators as depicted in FIG. 5 can be introduced as needed.

The contents of a query graph may be static, such as a name and a social security number, or changeable, such as ages (increasing as time passes by), hair color, etc. The results of a given query subgraph depend on when the query is made. Furthermore, the contents of the subgraph may be subject to different levels of privacy control such that some details (e.g., hair color) are available only for some people.

The query application 307 causes at least in part storage of the query RDF graph (Step 405), for example, in its own database 309a, or in external databases 309b, 309c, 309d, for further processing. Such processing may be as simple as responding to the query expressed in the query graph. For example, the RDF graph in FIG. 1 responds to the macro :call for Alice's personal details with her name and telephone number (see the following first example in Table 7). On the other hand, the RDF graph in FIG. 1 responds to :call for the personal details of Bob's pet Fido as “fail” (see the following second example in Table 7), since a dog is not a person thus has no personal details. If using a command of $ u_alice|:call_i PersonalDetails asks for Alice's personal details, this command will also cause a reply of “fail” due to mismatching of the macro :call_i with a type: PersonalDetails. As mentioned, the macro :call_i is applied to an instance, i.e., specific kind of information such as a pet's name, rather than a type (e.g., PersonalDetails) which is more frequently circulated information.

TABLE 7

$ u_alice | :call PersonalDetails
{ Alice, 010... }
$ u:fido | :call PersonalDetails
Fail

If the “else fail” clause in the last line of the query statement of Table 7 is replaced with the clause “else attempt” as shown in Table 8, the RDF graph in FIG. 1 responds to the macro :call for the personal detail of Bob's pet Fido as “{Fido}, attempted”. In one embodiment, queried objects may also be included in the reply by adding an option clause in the query statement as follows (see the third line of the following list). In this way, the reply includes queried objects therein (e.g., name, telephoneNumber, see last line of Table 8).

TABLE 8

| scope PersonDetails(x) | |
|---|---|
| where x.rdf_type in u_Person | |
| option describe(age), describe(telephoneNumber) | |
| then ( union | ( x \| name ) |

( x | age)
( x | hairColour )
( x | telephoneNumber )

)
else attempt.
$ u_alice | :call PersonalDetails
{ name−>Alice, telephoneNumber −>010... }

In addition to the macros :call and :call_i, the approach described herein may define and use other macros for finding the scope for a given query context. For example, a macro structure :call * can be defined to traverse a transitive closure over !rdf.type to find a query context scope. In addition, a macro structure :call_+ can be defined to traverse a reflexive transitive closure over !rdf.type to find scopes, and a macro structure :call(F) where F is a function which finds scopes by navigating potentially to anywhere in a target graph from the given scope. Transitive and reflexive transitive closure computations are fundamental inference capabilities for an RDF repository. For example, transitive and reflexive transitive closures provide the ability to express a function that generates new statements. Normally, transitive closure produces both existing and new statements. To provide the results expected from a transitive closure function the newly generated statements is merged together with the original base set of statements.

FIG. 5 is a diagram of expanded RDF classes according to one embodiment. In this embodiment, a new class “query” (e.g., query 515) is added as a subclass to a class “Scope” (e.g., scope 509) so as to express the query as an RDF subgraph. A “class” is an abstract type of object. An “object” is a “thing” 501 in a user's perceptual experience that is instantiated in markup languages by one or more elements and converted into the object-oriented pattern by a user agent application. Objects are instances of classes, which define the general characteristics of object instances. A “FailureMode” 503 is a mode or kind of failure in which there is lack of reply to the query. There are at least two failure modes: Fail, Attempt as enumerated previously. A “variable” 505 is an object capable of changing. A “language” 507 is one kind of RDF query language.

A “scope” 509 is the context within which a statement of a query or comment is valid. All scopes have a name which is specified as string type, nominally: xsd:string. An “option” 511 is a selectable object in a select list. Options are left freeform and behave like a compiler directive such as #pragma in the programming language Ada. A “command” 513 is a given instruction. A “query” 515 is a new class defined for use in the approach described herein and includes a request (e.g., a query) for information expressed as an RDF subgraph. As discussed previously, the incorporation of a query into the RDF class structure enables updates to the query to automatically update the corresponding query results with minimal or no user intervention. A “union” 517 of two or more classes includes the members of all those classes combined, and an “intersection” 519 of two or more classes includes the members that belong to every one of the classes. The “union” 517 of two (or more) classes constitutes a new class and the “intersection” 519 also constitutes a new class.

Specific properties of the classes in FIG. 5 are expanded according to the following descriptions in WQL as shown in Table 1. A “property” is an attribute that is essential to the nature of a given object. Properties mainly provide limitations on objects from the most general case implied by roles without properties applied. The descriptions define (1) object properties, such as “FailureMode”, “Query”, “Option”, “Scope”, “queryLanguage”, “Variable”, “thenClause”, “elseClause”, etc.; and (2) data type properties: “scopeName,” etc.

The descriptions in Table 9 define three standard query languages: WQL, SPARQL and)(Path, and three FailureModes: Fail, Attempt and None at the end of the Table. The descriptions further define a tree structure in FIG. 5 by specifying subclasses of the classes. For example, Intersection 519 is a subclass of Command 513, and Query 515 is subclasses of Scope 519.

TABLE 9
<?xml version=“1.0”?>
<rdf:RDF

xmlns:rdf=“http://www.w3.org/1999/02/22-rdf-syntax-ns#”
xmlns:owl=“http://www.w3.org/2002/07/owl#”
xmlns=“http://www.nokia.com/scope#”
xmlns:xsd=“http://www.w3.org/2001/XMLSchema#”
xmlns:rdfs=“http://www.w3.org/2000/01/rdf-schema#”

xml:base=“http://www.nokia.com/scope”>
<owl:Ontology rdf:about=“”/>
<owl:Class rdf:ID=“FailureMode”/>
<owl:Class rdf:ID=“Language”/>
<owl:Class rdf:ID=“Union”>

<rdfs:subClassOf>

<owl:Class rdf:ID=“Command”/>

</rdfs:subClassOf>

</owl:Class>
<owl:Class rdf:about=“#Command”>

<rdfs:subClassOf>

<owl:Class rdf:ID=“Scope”/>

</rdfs:subClassOf>
<owl:versionInfo rdf:datatype=“http://www.w3.org/2001/XMLSchema#string”
>TODO:</owl:versionInfo>

</owl:Class>
<owl:Class rdf:ID=“Variable”/>
<owl:Class rdf:ID=“Intersection”>

<rdfs:subClassOf rdf:resource=“#Command”/>

</owl:Class>
<owl:Class rdf:ID=“Option”/>
<owl:Class rdf:ID=“Query”>

<rdfs:subClassOf rdf:resource=“#Scope”/>

</owl:Class>
<owl:ObjectProperty rdf:ID=“queryLanguage”>

<rdfs:range rdf:resource=“#Language”/>
<rdfs:domain rdf:resource=“#Query”/>

</owl:ObjectProperty>
<owl:ObjectProperty rdf:ID=“options”>

<rdfs:range rdf:resource=“#Option”/>
<rdfs:domain rdf:resource=“#Scope”/>

</owl:ObjectProperty>
<owl:ObjectProperty rdf:ID=“variables”>

<rdfs:range rdf:resource=“#Variable”/>
<rdfs:domain rdf:resource=“#Scope”/>

</owl:ObjectProperty>
<owl:ObjectProperty rdf:ID=“thenClause”>

<rdfs:range rdf:resource=“#Query”/>
<rdfs:domain rdf:resource=“#Scope”/>

</owl:ObjectProperty>
<owl:ObjectProperty rdf:ID=“elseClause”>

<rdfs:range rdf:resource=“#FailureMode”/>
<rdfs:domain rdf:resource=“#Query”/>

</owl:ObjectProperty>
<owl:DatatypeProperty rdf:ID=“body”>

<rdfs:range rdf:resource=“http://www.w3.org/2001/XMLSchema#string”/>
<rdfs:domain rdf:resource=“#Query”/>

</owl:DatatypeProperty>
<owl:DatatypeProperty rdf:ID=“scopeName”>

<rdfs:range rdf:resource=“http://www.w3.org/2001/XMLSchema#string”/>
<rdfs:domain rdf:resource=“#Scope”/>

</owl:DatatypeProperty>
<owl:FunctionalProperty rdf:ID=“queries”>

<rdfs:range rdf:resource=“#Scope”/>
<rdfs: domain rdf:resource=“#Command”/>
<rdf:type rdf:resource=“http://www.w3.org/2002/07/owl#ObjectProperty”/>

</owl:FunctionalProperty>
<owl:AllDifferent>

<owl:distinctMembers rdf:parseType=“Collection”>

<Language rdf:ID=“WQL”/>
<Language rdf:ID=“SPARQL”/>
<Language rdf:ID=“XPath”/>

</owl:distinctMembers>

</owl:AllDifferent>
<owl:AllDifferent>

<owl:distinctMembers rdf:parseType=“Collection”>

<FailureMode rdf:ID=“Attempt”/>
<FailureMode rdf:ID=“Fail”/>
<FailureMode rdf:ID=“None”/>

</owl:distinctMembers>

</owl:AllDifferent>

</rdf:RDF>

The above description of the class structure can also be expressed as an RDF document in Table 10 as below:

TABLE 10
<?xml version=“1.0”?>
<!DOCTYPE rdf:RDF [

<!ENTITY scope “http://www.nokia.com/scope#” >
<!ENTITY owl “http://www.w3.org/2002/07/owl#” >
<!ENTITY xsd “http://www.w3.org/2001/XMLSchema#” >
<!ENTITY owl2xml “http://www.w3.org/2006/12/owl2-xml#” >
<!ENTITY rdfs “http://www.w3.org/2000/01/rdf-schema#” >
<!ENTITY rdf “http://www.w3.org/1999/02/22-rdf-syntax-ns#” >

]>
<rdf:RDF xmlns=“http://www.nokia.com/scope#”

xml:base=“http://www.nokia.com/scope”
xmlns:rdfs=“http://www.w3.org/2000/01/rdf-schema#”
xmlns:scope=“http://www.nokia.com/scope#”
xmlns:owl2xml=“http://www.w3.org/2006/12/owl2-xml#”
xmlns:owl=“http://www.w3.org/2002/07/owl#”
xmlns:xsd=“http://www.w3.org/2001/XMLSchema#”
xmlns:rdf=“http://www.w3.org/1999/02/22-rdf-syntax-ns#”>

<owl:Ontology rdf:about=“”/>
<!--
///////////////////////////////////////////////////////////////////////////////////////
//
// Object Properties
//
///////////////////////////////////////////////////////////////////////////////////////

-->

<!-- http://www.nokia.com/scope#elseClause -->
<owl:ObjectProperty rdf:about=“#elseClause”>

<rdfs:range rdf:resource=“#FailureMode”/>
<rdfs:domain rdf:resource=“#Query”/>

</owl:ObjectProperty>
<!-- http://www.nokia.com/scope#options -->
<owl:ObjectProperty rdf:about=“#options”>

<rdfs:range rdf:resource=“#Option”/>
<rdfs:domain rdf:resource=“#Scope”/>

</owl:ObjectProperty>
<!-- http://www.nokia.com/scope#queries -->
<owl:ObjectProperty rdf:about=“#queries”>

<rdf:type rdf:resource=“&owl;FunctionalProperty”/>
<rdfs:domain rdf:resource=“#Command”/>
<rdfs:range rdf:resource=“#Scope”/>

</owl:ObjectProperty>
<!-- http://www.nokia.com/scope#queryLanguage -->
<owl:ObjectProperty rdf:about=“#queryLanguage”>

<rdfs:range rdf:resource=“#Language”/>
<rdfs:domain rdf:resource=“#Query”/>

</owl:ObjectProperty>
<!-- http://www.nokia.com/scope#thenClause -->
<owl:ObjectProperty rdf:about=“#thenClause”>

<rdfs:range rdf:resource=“#Query”/>
<rdfs:domain rdf:resource=“#Scope”/>

</owl:ObjectProperty>
<!-- http://www.nokia.com/scope#variables -->
<owl:ObjectProperty rdf:about=“#variables”>

<rdfs:domain rdf:resource=“#Scope”/>
<rdfs:range rdf:resource=“#Variable”/>

</owl:ObjectProperty>
<!--
///////////////////////////////////////////////////////////////////////////////////////
//
// Data properties
//
///////////////////////////////////////////////////////////////////////////////////////

-->

<!-- http://www.nokia.com/scope#body -->
<owl:DatatypeProperty rdf:about=“#body”>

<rdfs:domain rdf:resource=“#Query”/>
<rdfs:range rdf:resource=“&xsd;string”/>

</owl:DatatypeProperty>
<!-- http://www.nokia.com/scope#scopeName -->
<owl:DatatypeProperty rdf:about=“#scopeName”>

<rdfs:domain rdf:resource=“#Scope”/>
<rdfs:range rdf:resource=“&xsd;string”/>

</owl:DatatypeProperty>
<!--
///////////////////////////////////////////////////////////////////////////////////////
//
// Classes
//
///////////////////////////////////////////////////////////////////////////////////////

-->

<!-- http://www.nokia.com/scope#Command -->
<owl:Class rdf:about=“#Command”>

<rdfs:subClassOf rdf:resource=“#Scope”/>
<owl:versionInfo
rdf:datatype=“&xsd;string”>TODO:</owl:versionInfo>

</owl:Class>
<!-- http://www.nokia.com/scope#FailureMode -->
<owl:Class rdf:about=“#FailureMode”/>
<!-- http://www.nokia.com/scope#Intersection -->
<owl:Class rdf:about=“#Intersection”>

<rdfs:subClassOf rdf:resource=“#Command”/>

</owl:Class>
<!-- http://www.nokia.com/scope#Language -->
<owl:Class rdf:about=“#Language”/>
<!-- http://www.nokia.com/scope#Option -->
<owl:Class rdf:about=“#Option”/>
<!-- http://www.nokia.com/scope#Query -->
<owl:Class rdf:about=“#Query”>

<rdfs:subClassOf rdf:resource=“#Scope”/>

</owl:Class>
<!-- http://www.nokia.com/scope#Scope -->
<owl:Class rdf:about=“#Scope”/>
<!-- http://www.nokia.com/scope#Union -->
<owl:Class rdf:about=“#Union”>

<rdfs:subClassOf rdf:resource=“#Command”/>

</owl:Class>
<!-- http://www.nokia.com/scope#Variable -->
<owl:Class rdf:about=“#Variable”/>
<!--
///////////////////////////////////////////////////////////////////////////////////////
//
// Individuals
//
///////////////////////////////////////////////////////////////////////////////////////

-- >

<!-- http://www.nokia.com/scope#Attempt -->
<FailureMode rdf:about=“#Attempt”/>
<!-- http://www.nokia.com/scope#Fail -->
<FailureMode rdf:about=“#Fail”/>
<!-- http://www.nokia.com/scope#None -->
<FailureMode rdf:about=“#None”/>
<!-- http://www.nokia.com/scope#SPARQL -->
<Language rdf:about=“#SPARQL”/>
<!-- http://www.nokia.com/scope#WQL -->
<Language rdf:about=“#WQL”/>
<!-- http://www.nokia.com/scope#XPath -->
<Language rdf:about=“#XPath”/>
<!--
///////////////////////////////////////////////////////////////////////////////////////
//
// General axioms
//
///////////////////////////////////////////////////////////////////////////////////////

-->

<rdf:Description>

<rdf:type rdf:resource=“&owl;AllDifferent”/>
<owl:distinctMembers rdf:parseType=“Collection”>

<rdf:Description rdf:about=“#None”/>
<rdf:Description rdf:about=“#Fail”/>
<rdf:Description rdf:about=“#Attempt”/>

</owl:distinctMembers>

</rdf:Description>
<rdf:Description>

<rdf:type rdf:resource=“&owl;AllDifferent”/>
<owl:distinctMembers rdf:parseType=“Collection”>

<rdf:Description rdf:about=“#SPARQL”/>
<rdf:Description rdf:about=“#XPath”/>
<rdf:Description rdf:about=“#WQL”/>

</owl:distinctMembers>

</rdf:Description>

</rdf:RDF>

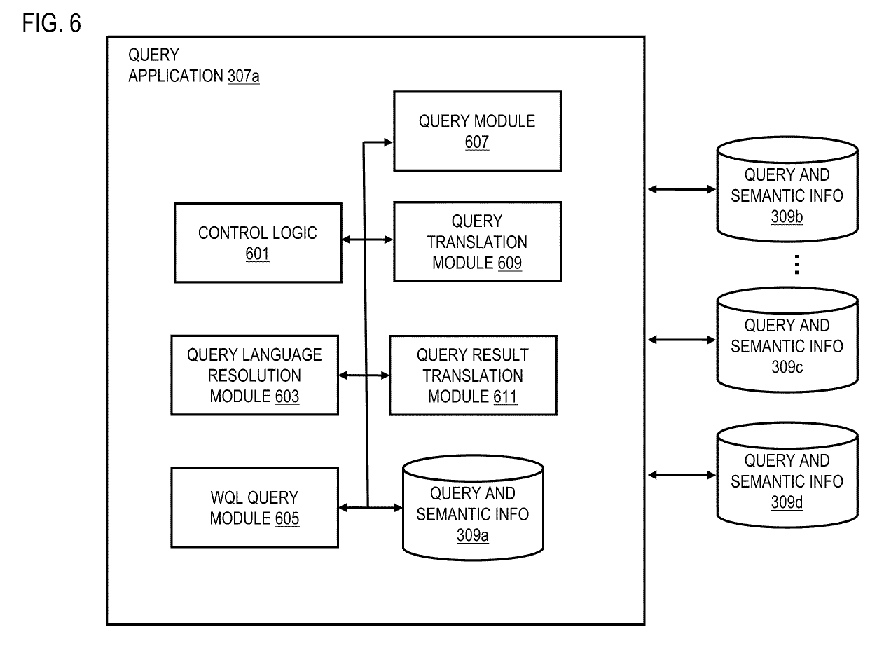

FIG. 6 is a diagram of the components of the query application 307a, according to one embodiment. By way of example, the query application 307a includes one or more components for creating and utilizing information representation of queries. It is contemplated that the functions of these components may be combined in one or more components or performed by other components of equivalent functionality. In this embodiment, the query application 307a includes at least a control logic 601 which executes at least one algorithm, stored in one or more memory modules, for performing query processing functions of the query application. The query application 307a also includes a query language resolution module 603 for determining the query language used in expressing an incoming query that is sent from a querying party as a RDF graph. Besides WQL, a query can be written in other RDF query languages such as SPARQL, DQL, N3QL, R-DEVICE, RDFQ, RDQ, RDQL, RQL/RVL, SeRQL, Versa, XUL, Adenine, etc.

The query application 307a also includes a WQL query module 605 for processing the incoming query in the default RDF query language WQL into a RDF graph according to a defined query scope (e.g., addressed to URI x to execute the getName function in FIG. 2A). In this embodiment, WQL is use as the default RDF query language. However, in other embodiments, other RDF query languages can be set as the default RDF query language. If the incoming query is determined by the query language resolution module 603 as written in WQL, the incoming query is sent to the WQL query module 605 to be processed into a query RDF graph in a query module 607 of the query application 307a. However, if the incoming query is determined by the query language resolution module 203 as written in a language other than WQL, the incoming query is sent to a query translation module 609 of the query application 307a to be translated into WQL, and then sent to the query module 607 to be processed into a query RDF graph. The query RDF graph is then saved in the query and semantic information database 309a. The query RDF graph can be searched within the internal database 309a for results via :call or :call_i (e.g., using :call to find names of people, and :call_i to find names of pets).

If the query results are in a format acceptable for the querying party, the results are directly sent to the querying party. However, if the query results are not in a format acceptable for the querying party, the results are sent to a query result translation module 611 of the query application 307a to be translated into a format acceptable for the querying party. The translated query results are then sent to the querying party.

Alternatively or concurrently, the query RDF graph is sent to one or more external databases to be searched therein for results via :call or :call_i. The external databases may be the query and semantic information database 309b of the personal computer 301b, the query and semantic information database 309c of the web service platform 303a, the query and semantic information database 309d of the communication platform 303b, other RDF databases in the semantic web, or a combination thereof. The query results are then sent to the query application 307a, and optionally processed via the query result translation module 611 as necessary.

When caching the query RDF graph into a local RDF database or storing the query RDF graph into an external RDF database, the query graph needs to be embedded into or merged with existing RDF graphs in the RDF database. The merger involves comparing the query graph with a most relevant existing graph, generating a set of differences, and updating the existing graph with the set of differences. For example, the query graph of “getName” of a person (within a broken line oval) is patched to the frame “Person” in the RDF graph in FIG. 2A, due to the relevancy of “person”.

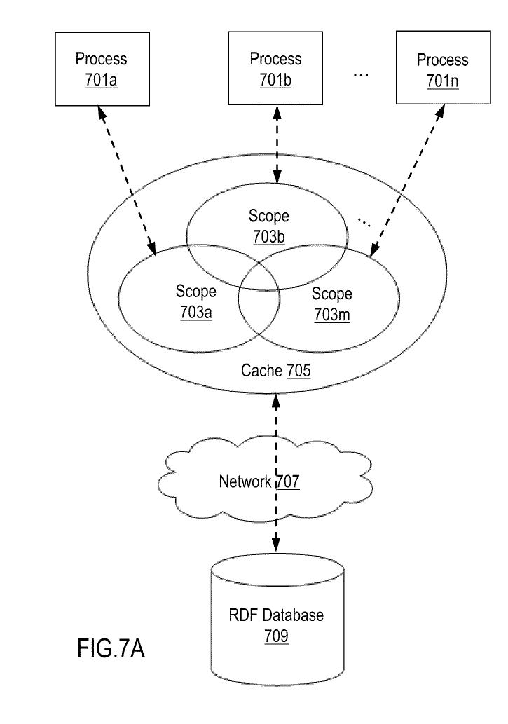

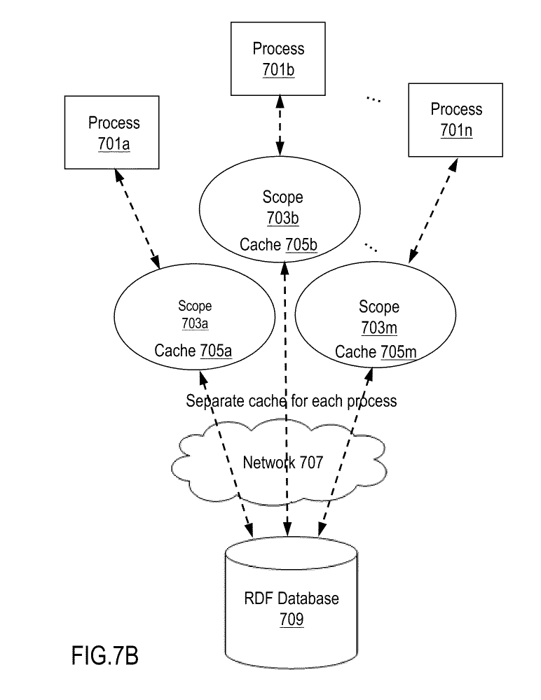

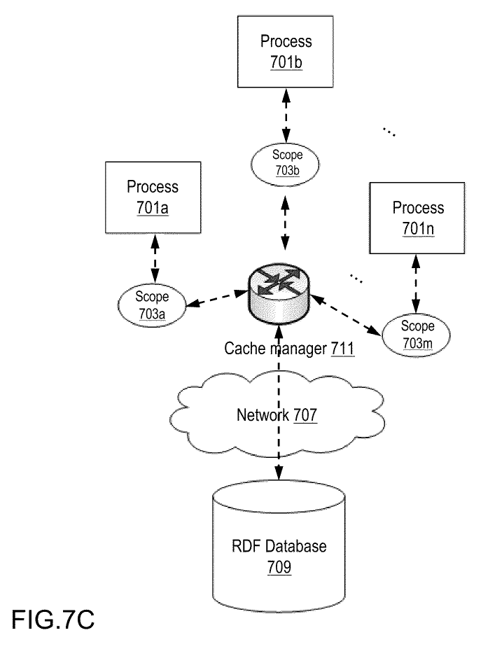

FIGS. 7A-7C are diagrams of query RDF graph caching, according to various embodiments. FIG. 7A shows that different processes 701 which generate query scopes 703 (“scopes”, i.e., query RDF graphs) and store the scopes 703 into a local cache 705. The cache 705 may reside in any equipment or devices connected to the semantic web, such as the UE 301a, the personal computer 301b, the web service platform 303a, the communication platform 303b, etc. When storing the scopes 703 into the cache 705 locally, if these scopes can be selectively merged due to their shared frames, properties, and/or objects, they are merged before sending out to an external database 709, so as to reduce data traffic on a communication network 707. The network 707 may be the communication network 305, or other types of networks connected to the semantic web.

In another embodiment, the scopes 703 is not suitable to be merged due to lack of shared frames, properties, and/or objects or other reasons, such as security, privacy, etc. In this case, different caches 705 are use to stored the scopes 703 generated via different processes 701 in a one-to-one manner as shown in FIG. 7B. The query application 307 then sends out the scopes 703 separately to the external database 709 via the network 707 without merger.

In the embodiment shown in FIG. 7C, the scopes 703 are separated for different ownership, or different security, confidentiality, and/or privacy controls. In these cases, the scopes 703 are not allowed to be merged locally. Nevertheless, they may be selectively merged at a designated cache manager 711 or the external database 709 as instructed by a user, network operator, or similar administrator. For example, a cache manger of a local branch of Bank A merges two deposit balance queries of two joint account holders into one query before sending it out to a central database of Bank A. On the other hand, the cache manger of the local branch of Bank A sends out two separate deposit balance queries of two competing grocery stores to the central database of Bank A, to avoid crossing confidential financial information between the competitors. The cache manager 711 may be a component of the query module 607 of the query application 307, or a device or application independent from the query module 607 and/or the query application 307.

In addition to local merger, the cache manager 711 also performs other operations on locally cached scopes 703, such as read, insert/write, delete, update, and query. These operations can also be performed by the query module 607 of the query application 307a, when the cache manager 711 is independent from the query application 307a.

In a read operation, the query application 307a provides a user agent application (i.e., a software agent of the user which sends out a query and performs other function for the user) with an iterator to the arcs of a subgraph of a query scope S so as to read the information therein. In an insert/write operation, the query application 307a inserts a subgraph G into the scope S thereby updating the scope S to include the subgraph G. In a delete operation, the query application 307a deletes a subgraph G from the scope S thereby updating the scope S to exclude the subgraph G. In an update operation, the query application 307a replaces a subgraph G1 in the scope S with a subgraph G2 thereby updating the scope S to include the subgraph G2 and to exclude the subgraph G1. In a query operation, the query application 307a finds one or more matched subgraphs in the scope S, and send them to the user agent application.

When there is no query result available in a local cache or when the user agent application specifically requests to search against one or more external databases, the query application 307a coordinates with the external databases to perform the read, insert/write, delete, update, and query operations. The cache manager 711 also performs other operations, such as subscribe and notify, in conjunction with the external databases. In a subscribe operation, the query application 307a sends out a persistent query to the external databases to have them continue updating any changes to the scope S. In a notify operation, the query application 307a sends out a subscription to the external databases and then receives any changes of the scope S via a notification from the external databases.

The cache manager 711 further performs external synchronization between locally cached scopes 703 and corresponding scopes stored in one or more external databases, when there is a change to the locally or externally cached scopes 703.

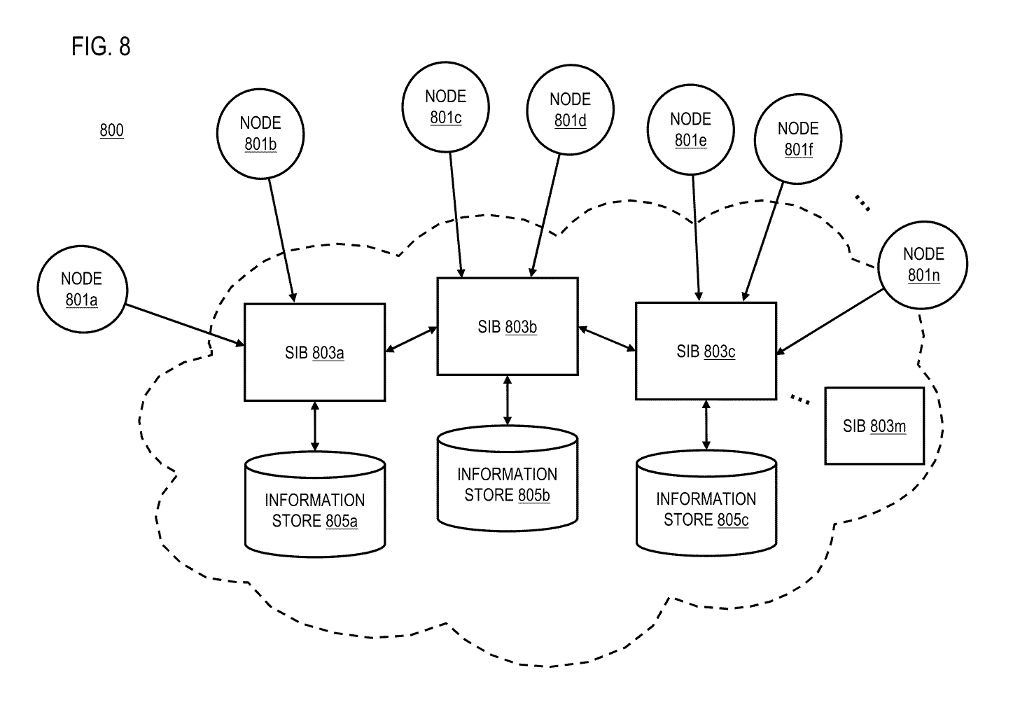

FIG. 8 is a diagram of a smart space logical architecture, according to one embodiment. A “smart space” refers to a plurality of information spaces of different entities in a “smart space architecture” that allows the entities and different semantic web tools to access heterogeneous information embedded in different semantic domains available for different semantic web tools as described herein. The smart spaces maintain privacy of personal information while allowing users to search over different ontology domains, different platforms, different equipment, and different vendors in the semantic web.

The semantic web is designed to share information based upon common representation formats, ontologies and semantics, such that information would become globally ubiquitous and interoperable. However much of the information is not desired to ubiquitous, but remain hidden, private and is interpreted locally, such as personal information. To address to this issue, a smart space architecture (an entity focused structure) is developed such that a user can encapsulate all of personal information and interact with the information in the smart space according to the user's individual semantics and needs. The user can be a person, an organization, or other entity. In addition, nodes 801 are provided in the smart space 800 as dynamic query resolution agencies which carry at least functions of the user agent application as discussed in the semantic web. Semantic information brokers (SIB) 803 are provided in the smart space 800 as entities performing information transaction operations. Local SIBs carry at least functions of the RDF cache or the cache manger while remote SIBs carry at least functions of the external databases as discussed in the semantic web.

An individual smart space 800 of the user is aggregated information set with information from different sources related to the user. For example, sources of the user's personal information, family information, work information, social network information, etc. includes include (1) government records and databases, (2) employer databases; (3) credit card companies, banks, credit bureau database; (4) marketing survey and data mining databases, (5) user online behavior databases (browsing by a user via Internet, information mentioned by the user in the user's e-mails, calendar appointments, etc, (6) media items (articles, music, video, photos, etc. posted in blogs on web pages, etc.) created by the user, (7) articles, music, video, photos, etc. captured by the user, etc. These information contents are private and remain segregated from other information in the semantic web to protect the user's privacy. Only authenticated and authorized nodes, such as a credit card company of a bank of the user, are allowed to access the user's personal smart space to share the information such as the user's financial information, payment transactions, etc. stored in a local SIB (e.g., which resides in the UE 301a).

With the personal information, nodes of the credit card company and the bank can facilitate the purchase by the user via interacting with the node of the UE 301a, with minimum or even no user involvement. For example, when the user browses a website for flight tickets, a website node interacts with the UE node to prompt the user to selecting tickets that fit the user's criteria. The user can tap one the screen of the UE 301a to select tickets, the UE node then informs the website node to go ahead charging the user's credit card for the tickets, without asking the user to enter financial data.

As seen in FIG. 8, each smart space is distributed across at least one set of nodes belonging to at least one user. In this embodiment, the smart space 800 is distributed across multiple nodes 801a-801n that each belong to multiple users. For example, nodes 801a and 801b belong to a first user, while nodes 801c-801f belong to a second user. It is also contemplated that one or more of the nodes (e.g., node 801n) may belong to a centralized information provider. Nodes 801 are personal/individual in that they perform tasks either directly decided by the user or autonomously for or on behalf of the user. For example, the nodes 801 can monitor predetermined situations or reason/data-mine information available in the smart space 800.

A node 801 may connect to one or more smart spaces 800 at a time. Moreover, the specific smart spaces 800 and to which the node 801 is connected may vary over the lifetime of a node. Mobility of nodes 801 is provided by moving links to the smart space 800 rather than moving a physical running process of the smart space 800. The node 801 can save its state and become ‘mobile’ when another node 801 restores that state. Nodes 801 themselves are anonymous and independent of each other—there is no explicit control flow between the nodes 801 other than that provided through preconditions to node actions. A coordination model based around expressing coordination structures as first-order entities and focusing on collecting reasoning and context. Control flow can be made outside of the smart space 800 through nodes 801 and the applications serving the nodes 801 explicitly sharing details of their external interfaces through the smart space 800. The responsibilities of nodes 801 range from user-interaction to reasoning and performing tasks such as truth maintenance, belief revision, information consistency management etc.

The nodes 801 access information in the smart space 800 through the SIBs 803a-803m by connecting to any of the SIBs 803 making up the smart space 800 by whatever connectivity mechanisms (e.g., connectivity over a data network, the Internet, etc.) the SIBs 803 offer. Usually, the connection is over some network (e.g., data network, wireless network, telephony network, service provider network, etc.), and the nodes 801 are running on various devices.

Each SIB 803 performs information transaction operations, possibly co-operating with other SIBs 803, for the smart space 800. In one embodiment, an SIB 803 may be a concrete or virtual entity. Each SIB 803 supports nodes 801 interacting with other SIBs 803 through information transaction operations. In this embodiment, the smart space 800 includes SIBs 803a-803m each connected to respective information stores 805a-805c. Each information store 805 of the smart space 800 stores the information of the nodes 801, and any other information available over the smart space 800. This can include, for example, information of a current state or activity of the node 801, observations of the outside information world, maintenance information, and the like. Synchronization between these distributed, individual information stores 805 is asymmetric according to device and network capabilities as well as the user's needs in terms of security, privacy, etc. For example, private information about a user's family is stored at the user's home location where stricter information security policies can protect the information. The private information can then be augmented by non-private information at a website (e.g., a social networking website) without actually transferring the private information to the website. In this case, augmenting information is preferable to merging information due to, for instance, copyright and/or privacy concerns.

Interaction among smart spaces 800 is nominally conducted by the nodes 801 which encapsulate fine grained functionality to be distributed across any number of devices that have access to one or more of the smart spaces 800. The smart spaces 800 themselves can interact through merging and projection thereby enabling larger smart spaces 800 to be constructed either on a permanent or temporary basis. Moreover, the smart space 800 may be a personal space, a share/social space of at least two users, a group space, a public space of a community, a county, a state, or a county, etc., and the like. The aggregation of all smart spaces 800 constitutes the world of information (including the semantic web) which is also referred to as a smart space. A smart space 800 including the entire world of information also supports all services (including all platforms and vendors) available in the world, as well as all of the world's devices and equipment.

The smart space 800 is interoperable over different information domains, different service platforms, and different devices and equipment. For example, the smart space 800 accommodates transmission control protocol/Internet protocol (TCP/IP), Unified Protocol (UniPro) created by the Mobile Industry Processor Interface (MIPI) Alliance, Bluetooth protocol Radio Frequency Communication (RFCOMM), IPv6 over Low power Wireless Personal Area Networks (6LoWPAN), etc. The smart space 800 also covers technologies used for discovering and using services, such as Bluetooth/human interface device (HID) services, web services, services certified by the Digital Living Network Alliance (DLNA), the Network on Terminal Architecture (NoTA), etc. The smart space constitutes an infrastructure that enables scalable producer-consumer transactions for information, and supports multiparts, multidevices and multivendors (M3), via a common representation of a set of concepts within a domain (such as a RDF domain) and the relationships between those concepts, i.e. ontologies. The smart space 800 as a logical architecture has no dependencies on any network architecture but it is implemented on top of practically any connectivity solution. Since there is no specific service level architecture in the smart space 800, the smart space 800 has no limitation in physical distance or transport. The smart space 800 architecture allows user devices purchased at different times and from different vendors to work together. For example, the user can listen/watch/etc. to music/movies/etc. wherever the user is using one personal device in the vicinity of high quality speakers or display. In addition, the smart space 800 architecture allows application developers to mash-up services in different domains, instead of trying to port an application to all platforms and configurations. The smart space architecture also allows device manufacturers to make interoperable products, so that consumers have no concern about compatibility of different products and accessories.

A smart space 800 transcends over many of the user's devices (e.g., mobile phones, media centers, personal computers, servers, routers, etc.) enabling the distribution of information and queries upon that information over any of the user's devices. For any node 801 accessing the information, the physical location of the node 801 and the location of the information are irrelevant, i.e., a node 801 sees the ‘totality’ of all information in that smart space 800. By way of example, the nodes 801 access the smart space 800 with basic operations including Insert (to insert information into a smart space), Remove (to remove information from a smart space), Update (to update information in a smart space, which is effectively an atomic remove and insert combination), Query (to query for information in a smart space), Subscribe (to set up a persistent query in a smart space such that a change in the query results is communicated to the subscribing node), other query management operations (e.g., notification, etc.) as discussed with respect to the query application 307a, etc. The nodes 801 communicate implicitly by inserting information to the smart space 800 and querying the information in the space 800.

Various embodiments are described herein with respect to query management in the semantic web and the smart space. By way of example, RDF is used in the smart space 800 to store information in information stores 805a-805c. RDF allows joining data in vocabularies from different business domains without having to negotiate structural differences between the vocabularies. In addition, via the RDF, the smart space 800 merges the information of the embedded domains with the information on the semantic web, as well as makes the vast reasoning and ontology theories, practices and tools developed by the semantic web community available for application development in the smart space 800. The smart space 800 also makes the heterogeneous information in embedded domains available to the semantic web tools.

As discussed, the query management operations can be implemented at the level of RDF triples. The query application 307a inserts RDF triples to a scope 51 that corresponds to an RDF subgraph on a remote RDF store. To client C1, the insert operation completes without incurring the delay of network access to a remote RDF store. After completing the insert operation by client C1, the query application 307a checks if there are RDF triples belonging to intersections between scope S1 and any other scope maintained for client C1. For any such scope, client C1 that has subscribed to changes in the scope S1 is notified. The triples will be read from the local cache if a copy is the available and recently updated. The RDF triples are deleted, updated, synchronized (between a local cache and a remote database) as discussed with respect to the external databases in the semantic web.

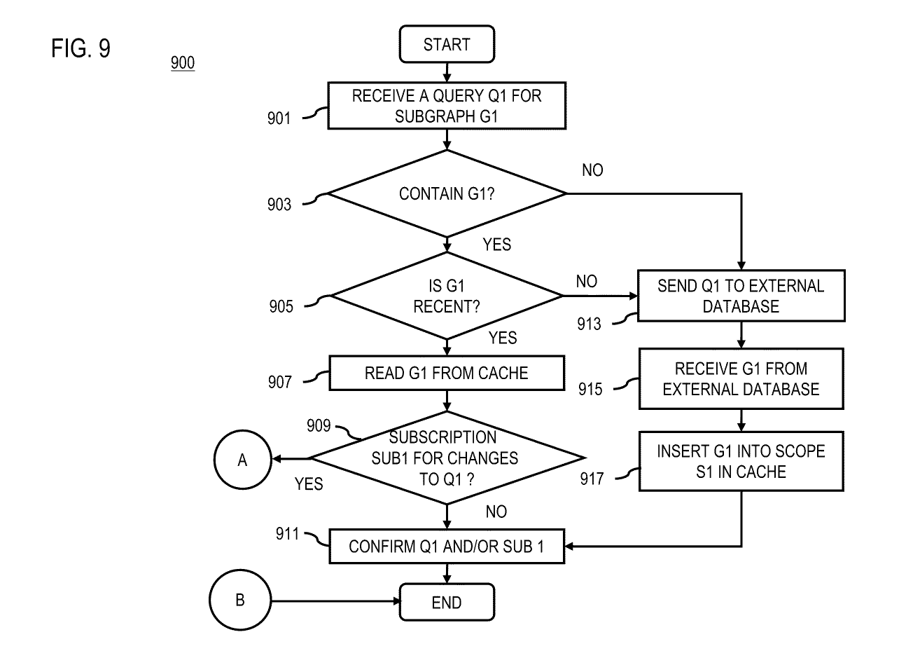

FIG. 9 is a flowchart of a process for query, insert, and subscribe operations, according to one embodiment. In this embodiment, the query application 307a performs the process 900 and is implemented in, for instance, a chip set including a processor and a memory as shown FIG. 13. In step 901, the query application 307a (e.g., of a sports good store in a shopping mall) receives a query Q1 from a user's agent application (e.g., stored in the UE 301a, a smart phone, etc.) to see if there are running shoes on sale. By way of example, the user maintains a shopping list on the UE 301a which includes a pair of running shoes. To simplify the discussion, only one item is used as an example. The number of items on the list is unlimited.

The process 900 occurs when the user walks in the mall where the sports good store is located. There are communication signals exchanged and authenticated between the user's agent application of the UE 301a and the query application 307a of the mall, so as to exchange information authorized by the user of the UE 301a to a node of the sports good store. For example, the user has preset conditions for receiving sales information if (1) there are no appointments in the user's calendar for the rest of the day, and (2) the store has items on sale which are in the user's shopping list. If both conditions are met, as the user walks by the sports good store, the user feels the UE 301a vibrates which indicates there is something of interest in the proximity.

In addition, a query application 307a in the UE 301 node or the mall node recommends local objects of interest if there is free time in the user's calendar, by discovering objects of interest in proximity and checking the user's calendar for free time. The recommendations can be made with more specificity according to the level of specificity of the query. For example, the query application 307a may recommend product advertisements of nearby shops. The query application 307a may also recommend product advertisements of nearby shops only for shopping list items. As another option, the query application 307a may recommend product advertisements of nearby shops only for shopping list items with special offers. In addition, the query application 307a may specify for the user product advertisements that include product(s) in user's shopping list and provide relevant special offers and/or discounts for the products.

When the user looks at the screen on the UE 301a and sees an offer for running shoes from the nearby sports good store at a discount, the user can select the offer shown on the screen. A compass arrow is then, for instance, shown on the screen pointing to the entrance of the sporting goods store, and indicating a distance and/or location of the store. The screen on the UE 301a may also shows a weblink to a free download of a runners' training video from the store, the manufacturer, or the designer of the shoes. The screen on the UE 301a can also display shop information, such as location, a list of products advertised, a list of product categories, prices, vendor (this sports good store/a manufacturer store/ . . . ), where to obtain the product (from this store/via download/ . . . ), a list of product combinations as advertised, a list of products in a combination, discounted prices of the combinations.

The pair of running shoes is specified in a query Q1 with the user's background information, such as male, US shoe size 11, etc. When the user gets closer to the store or inside the store, the query application 307a of the store node receives Q1, expresses Q1 as a subgraph G1 and searched within the local cache or database 309a of the store to see if G1 is contained therein (Step 903). If G1 is in the local cache or database 309a of the store, the query application 307a further checks if G1 is recent (Step 905), for example, within one year. The criterion for “recent” is predetermined depending on the types of products or services. For adults' shoes, one year is recent enough. However, for children's shoes, 3 months may be recent since children's feet grow fast.

If there is a recent G1 available in the database 309a, the query application 307a of the store node reads G1 from the local cache or database 309a (Step 907). The query application 307a then asks the users' agent application to see if the user would like to subscribe for changes to Q1 for future information (Step 907), such as coming promotion and sales of the same or similar kinds of shoes. If the user is not interested in subscribing to the changes, the query application 307a confirms to the user's agent application that Q1 (i.e., the query for male size 11 shoes) has already been expressed as G1 inserted in a scope 51 in the local cache or database 309a of the sports good store (Step 911), and then proceeds to retrieve search results for the user.

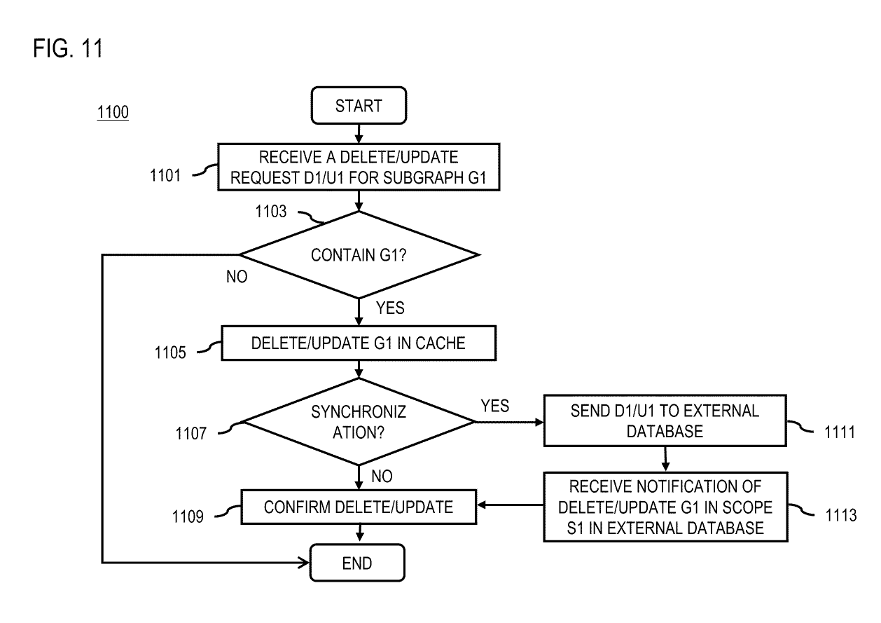

If the user is interested in subscribing to the changes, or if the subscription SUB 1 to changes of Q1 is preset by the user in conjunction with the shopping list (to receive the subscription together with Q1), the query application 307a proceeds to a subscribe operation. The details of subscription will be discussion with FIG. 11 later. After the subscribe operation, the query application 307a confirms to the user's agent application of that the Q1 and SUB1 have already been applied to the local cache or database 309a (Step 911), and proceeds to retrieve search results for the user and updates the user any changes to the query when the changes occurs.

If G1 is not in the local cache or database 309a (Step 903) or G1 is not recent (Step 905), the query application 307a of the store node sends Q1 to one or more external databases (Step 913). Each of the external databases then perform steps similar to steps 903-907 to check if they contain G1 therein and if G1 is recent, then send G1 to the query application 307a. After receiving G1 from the eternal databases (Step 915), the query application 307a inserts G1 into a scope 51 in the local cache or database 309a (Step 917), then confirms to the user's agent application that the Q1 (i.e., query for male size 11 shoes) has already been expressed as G1 inserted in a scope 51 in the local cache or database 309a of the sports good store (Step 911), and then proceeds to retrieve search results for the user.

In addition, the query application 307a of the store node further sends signals to the user's agent application to display on the screen of the UE 301a that the store also sells cyclists' sun glasses which is on the user's shopping list. The query application 307a then asks the user to try on the shoes and the sun glasses. The user may pay for the purchases with a cashier at the store. As the user walks towards the car, the user notices that query application 307a of the UE node has started downloading the training video and sending updates via his subscription for shoes sale.

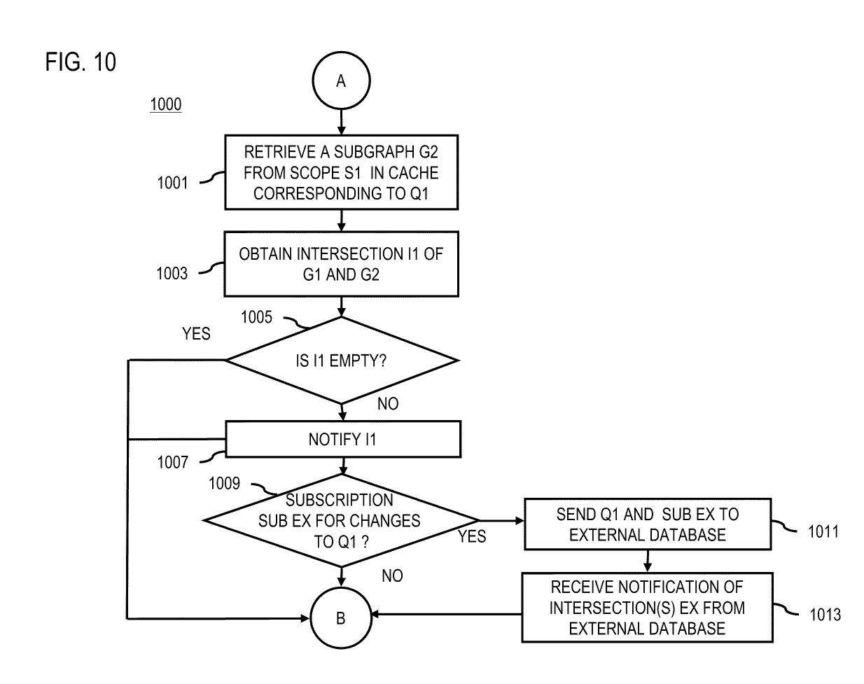

FIG. 10 is a flowchart of a process for local and external subscription, according to one embodiment. In one embodiment, the query application 307a performs the process 1000 continuing from the step 909 of FIG. 9 and is implemented in, for instance, a chip set including a processor and a memory as shown FIG. 13. As mentioned, the user can subscribe when sending out Q1 or after sending out Q1. When the store has spontaneous sale for half an hour during the user's visit, due to the subscription to the changes of running shoes prices and models, the user can take advantage of the spontaneous sale. In step 1001, the query application 307a of the store node retrieves a subgraph G2 of a sale of similar running shoes in the cache. The query application 307a obtains intersection I1 of G1 and G2 to see if they overlap (Step 1003). If G1 and G2 overlap with each other such that I1 is not empty (Step 1005), the query application 307a of the store node notifies the user's agent application that there is update/changes to Q1 (routing the process 1000 back to the END of the process 900) by serializing I1 and notifying the user agent application of I1 (Step 1007). If G1 and G2 do not overlap with each other such that I1 is empty (Step 1005), the query application 307a notifies the user's agent application that there is no update/changes to Q1 (also routing the process 1000 to the END of the process 900).

The query application 307a then asks the user's agent application if the user is interested in subscribing to changes of Q1 in one or more external databases (“SUB Ex”) (Step 1009). The external databases may be databases of another sports good store of the same chain at another location which is also convenient for the user, or stores of other running shoes manufacturers, etc. If the user is interested in subscribing to the external database, the query application 307a sends Q1 and SUB EX to the external databases (Step 1011). The external databases then performs steps similar to Steps 1003-1007, and send out notification of intersections of G1 and G2 (“I EX”) if available. The query application 307a of the store receives notifications of intersections from external database(s) (Step 1013). The query application 307a then notifies the user's agent application that there are update/changes to Q1 (routing the process 1000 to the END of the process 900). The query application 307a can contact the external databases sequentially or simultaneously.

FIG. 11 is a flowchart of a process for delete and update operations, according to one embodiment. In one embodiment, the query application 307a performs the process 1100 and is implemented in, for instance, a chip set including a processor and a memory as shown FIG. 13. In step 1101, the query application 307a receives a delete request D1 or an update request U1 for subgraph G1. For example, the user may delete an item (e.g., a long winter coat) that the user is no longer interested after a purchase of the item. The user may want to update an item in case of criteria changes (e.g., gaining weight requires changing clothes sizes). If G1 is not available in the local cache or database 309a (Step 1103), the query application 307a of the store node ends the process 1100 (Step 1105). If G1 is available in the local cache or database 309a (Step 1103), the query application 307a deletes/updates G1 in the scope 51 in the local cache or database 309a (Step 1105).

The query application 307a then asks the user's agent application if the user is interested in synchronizing the local cache or database 309a with one or more external databases (Step 1107) to make the G1 consistent in the local cache and in the external databases when a change to Q1 occurs. The user may selectively delete/update an item at only one or some of the databases. If the user is not interested in synchronizing G1, the query application 307a confirms the delete/update operation at the local cache or database 309a with the user's agent application (Step 1109).

If the user is interested in synchronizing G1, the query application 307a of the store node sends D1/U1 to the external databases (Step 1111). The external databases delete/update the item accordingly, and send out notification to the query application 307a (Step 1113). The query application 307a then confirms the delete/update operation at the external databases with the user's agent application (Step 1109).

Referring back to the shopping list example, an individual smart space 800 of the user, who wants to buy a pair of running shoes if the user has time and if the running shoes are on sale, is an aggregated information set with information from different sources related to the user. Only authenticated and authorized nodes, such as the one in the sporting goods store, are allowed to access the user's personal smart space to share the information such as the user's calendar, shopping list, other objects of interest, preferred shopping locations, payment transactions, etc. stored in a local SIB reside in the UE 301a (e.g., a mobile phone, a mobile smart device, etc.).

With the personal information, nodes can facilitate the purchase of the running shoes by interaction mostly automatically with the node of the UE 301a, with minimal or even no user involvement. For example, when the user approaches the sporting goods store, a store node starts interact with the UE node to cue the user to visit the store. After the user walks into the store, the store node prompts the UE 301a to display where the selections of running shoes that fit the user's criteria are. The user can try on the shoes, and then tap the screen of the UE 301a which then informs the store node to charge the user's credit card for the shoes. After the store node finishes the transaction, it informs a store gate node that the running shoes have been paid for and the user is free to walk away with the shoes. The store gate node then deactivates any anti-theft mechanism for the shoes such that the user can freely leave the store with the shoes. Meanwhile, the store node also informs the UE node that the transaction is complete and the user can leave with the shoes.

The processes described herein for creating and utilizing information representation of queries may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

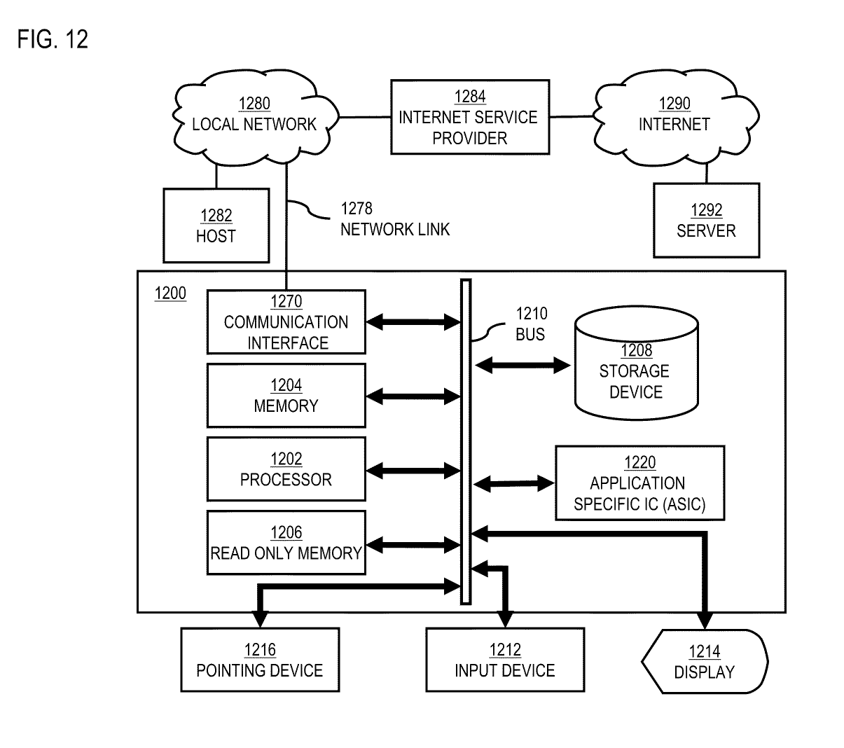

FIG. 12 illustrates a computer system 1200 upon which an embodiment of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to create and utilize information representation of queries as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of creating and utilizing information representation of queries.

A bus 1210 includes one or more parallel conductors of information so that information is transferred quickly among devices coupled to the bus 1210. One or more processors 1202 for processing information are coupled with the bus 1210.

A processor 1202 performs a set of operations on information as specified by computer program code related to create and utilize information representation of queries. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1200 also includes a memory 1204 coupled to bus 1210. The memory 1204, such as a random access memory (RAM) or other dynamic storage device, stores information including processor instructions for creating and utilizing information representation of queries. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for creating and utilizing information representation of queries, is provided to the bus 1210 for use by the processor from an external input device 1212, such as a keyboard containing alphanumeric keys operated by a human user, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT) or a liquid crystal display (LCD), or plasma screen or printer for presenting text or images, and a pointing device 1216, such as a mouse or a trackball or cursor direction keys, or motion sensor, for controlling a position of a small cursor image presented on the display 1214 and issuing commands associated with graphical elements presented on the display 1214. In some embodiments, for example, in embodiments in which the computer system 1200 performs all functions automatically without human input, one or more of external input device 1212, display device 1214 and pointing device 1216 is omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of application specific ICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection between the UE 301a and the communication network 105 for creating and utilizing information representation of queries.

The term computer-readable medium is used herein to refer to any medium that participates in providing information to processor 1202, including instructions for execution. Such a medium may take many forms, including, but not limited to, non-volatile media, volatile media and transmission media. Non-volatile media include, for example, optical or magnetic disks, such as storage device 1208. Volatile media include, for example, dynamic memory 1204. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

FIG. 13 illustrates a chip set 1300 upon which an embodiment of the invention may be implemented. Chip set 1300 is programmed to create and utilize information representation of queries as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1300, or a portion thereof, constitutes a means for performing one or more steps of creating and utilizing information representation of queries.

In one embodiment, the chip set 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to create and utilize information representation of queries. The memory 1305 also stores the data associated with or generated by the execution of the inventive steps.

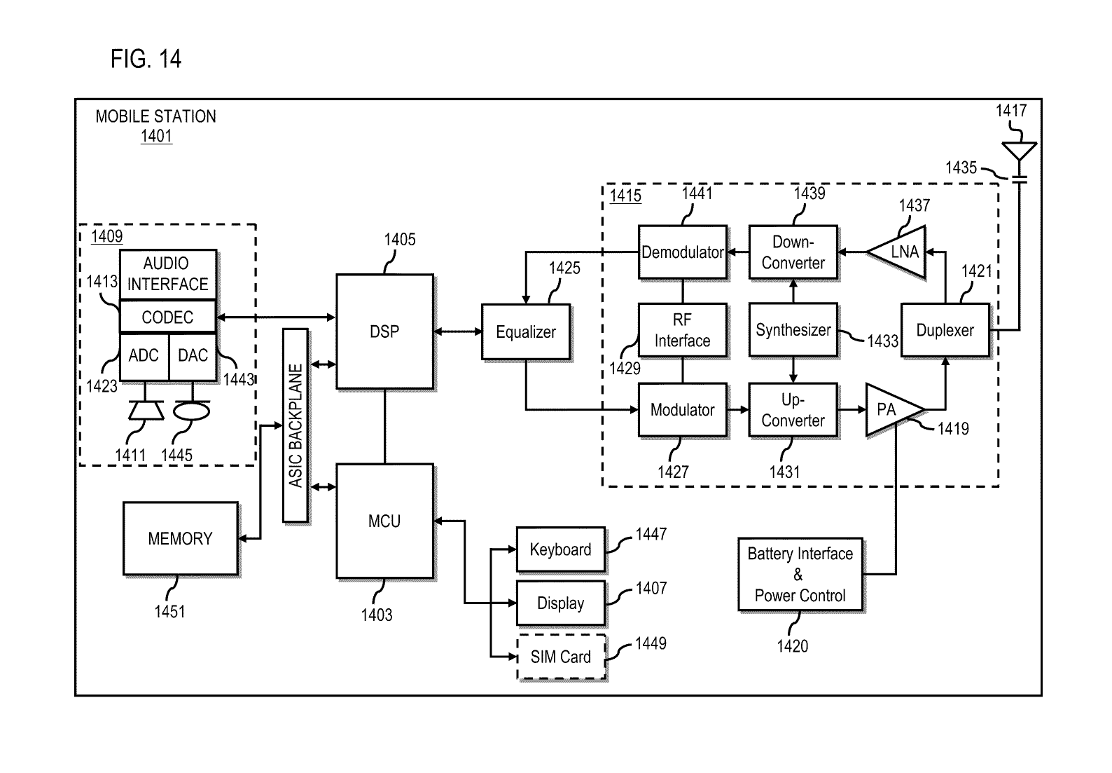

FIG. 14 is a diagram of exemplary components of a mobile terminal (e.g., handset) for communications, which is capable of operating in the system of FIG. 1, according to one embodiment. In some embodiments, mobile terminal 1400, or a portion thereof, constitutes a means for performing one or more steps of creating and utilizing information representation of queries. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application, the term “circuitry” would also cover an implementation of merely a processor (or multiple processors) and its (or their) accompanying software/or firmware. The term “circuitry” would also cover, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of creating and utilizing information representation of queries. The display 14 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403—which can be implemented as a Central Processing Unit (CPU) (not shown).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to create and utilize information representation of queries. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a query;
expressing the query as a resource description framework graph; and
causing at least in part storage of the query resource description framework graph.

2. A method of claim 1, further comprising:
causing at least in part synchronizing or embedding of the query resource description framework graph in a resource description framework graph or another query resource description framework graph.

3. A method of claim 1, further comprising:
causing at least in part sending of the query resource description framework graph over an information space to a receiving party;
causing at least in part storing and interpreting by the receiving party of the query resource description framework graph; and
causing at least in part returning of results of the query at run-time.

4. A method of claim 3, further comprising:
translating the query in a first resource description framework query language into a default resource description framework query language.

5. A method of claim 4, further comprising:
translating the results of the query expressed as a resource description framework structure to an information representation format corresponding to the first resource description framework query language.

6. A method of claim 3, further comprising:
causing at least in part subscription to a change of the query;
causing at least in part notification of the change; and
causing at least in part synchronization between the changed query resource description framework graph and a corresponding query resource description framework graph stored elsewhere, when the change occurs.

7. A method of claim 6, further comprising:
updating the results of the query by the receiving party when the query is changed; and
causing at least in part notification of the updated results of the query.

8. An apparatus comprising:
at least one processor; and
at least one memory including computer program code,
the at least one memory and the computer program code configured to, with the at least one processor, cause the apparatus to perform at least the following, receive a query;
express the query as a resource description framework graph; and
cause at least in part storage of the query resource description framework graph.

9. An apparatus of claim 8, wherein the apparatus is further caused to:
cause at least in part synchronizing or embedding of the query resource description framework graph in a resource description framework graph or another query resource description framework graph.

10. An apparatus of claim 8, wherein the apparatus is further caused to:
cause at least in part sending of the query resource description framework graph over an information space to a receiving party;
cause at least in part storing and interpreting by the receiving party of the query resource description framework graph; and
cause at least in part returning of results of the query at run-time.

11. An apparatus of claim 10, wherein the apparatus is further caused to:
translate the query in a first resource description framework query language into a default resource description framework query language.

12. An apparatus of claim 11, wherein the apparatus is further caused to:
translate the results of the query expressed as a resource description framework structure to an information representation format corresponding to the first resource description framework query language.

13. An apparatus of claim 10, wherein the apparatus is further caused to:
cause at least in part subscription to a change of the query;
cause at least in part notification of the change; and
cause at least in part synchronization between the changed query resource description framework graph and a corresponding query resource description framework graph stored elsewhere, when the change occurs.

14. An apparatus of claim 13, wherein the apparatus is further caused to:
update the results of the query by the receiving party when the query is changed; and
cause at least in part notification of the updated results of the query.

15. A computer-readable storage medium carrying one or more sequences of one or more instructions which, when executed by one or more processors, cause the one or more processors to at least perform the following steps:
receiving a query;
expressing the query as a resource description framework graph; and
causing at least in part storage of the query resource description framework graph.

16. A computer-readable storage medium of claim 15, wherein the apparatus is caused to further perform:
causing at least in part synchronizing or embedding of the query resource description framework graph in a resource description framework graph or another query resource description framework graph.

17. A computer-readable storage medium of claim 15, wherein the apparatus is caused to further perform:
causing at least in part sending of the query resource description framework graph over an information space to a receiving party;
causing at least in part storing and interpreting by the receiving party of the query resource description framework graph; and
causing at least in part returning of results of the query at run-time.

18. A computer-readable storage medium of claim 17, wherein the apparatus is caused to further perform:
translating the query in a first resource description framework query language into a default resource description framework query language.

19. A computer-readable storage medium of claim 18, wherein the apparatus is caused to further perform:
translating the results of the query expressed as a resource description framework structure to an information representation format corresponding to the first resource description framework query language.

20. A computer-readable storage medium of claim 17, wherein the apparatus is caused to further perform:
causing at least in part subscription to a change of the query;
causing at least in part notification of the change; and
causing at least in part synchronization between the changed query resource description framework graph and a corresponding query resource description framework graph stored elsewhere, when the change occurs.
